(19) United States
(12) Patent Application Publication
(10) Pub. No.: US 2008/0137975 A1
(43) Pub. Date: Jun. 12, 2008

(54) Decoder, decoding method and computer readable medium

(75) Inventors: Hiroshi Kawazoe, Yokohama-Shi (JP); Yasuyuki Nishibayashi, Kawasaki-Shi (JP); Masataka Goto, Yokohama-Shi (JP); Shinya Murai, Kawasaki-Shi (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 11/979,556

(22) Filed: Nov. 5, 2007

(30) Foreign Application Priority Data
Nov. 7, 2006 (JP) 2006-301695

(51) Int. Cl. G06K 9/36

(52) U.S. Cl. 382/250; 382/251

(57) ABSTRACT

There is provided with a decoder which decodes coded image data obtained by applying entropy coding to first data obtained by applying a discrete cosine transform and quantization processing to image data, including: a first decoding unit configured to apply entropy-decoding to the coded image data to obtain the first data; a dividing unit configured to divide the first data into a plurality of second data each of which has a size equal to or smaller than a first threshold; and a second decoding unit configured to apply inverse quantization processing and inverse discrete cosine transform to each second data sequentially to obtain a plurality of third data, and a generating unit configured to generate the image data by synthesizing the plurality of third data.

### CROSS-REFERENCE TO RELATED APPLICATIONS

This application is based upon and claims the benefit of priority from the prior Japanese Patent Applications No. 2006-301695 filed on Nov. 7, 2006, the entire contents of which are incorporated herein by reference.

### BACKGROUND OF THE INVENTION

1. Field of the Invention

The present invention relates to a decoder, a decoding method and a computer readable medium.

2. Related Art

JPEG (Joint Photographic Experts Group) which is an image coding scheme currently being widely used performs coding processing: using a procedure which is roughly divided into the following two stages. In a discrete cosine transform (DCT) and quantization processing which is a first coding procedure, an image inputted is divided into a plurality of blocks, each block is subjected to a discrete cosine transform, transformed into a transformation coefficient and then the amount of information is reduced through quantization. Entropy coding which is a second coding procedure uses a technique such as Huffman coding assigning short codes to symbols having a high occurrence rate and by contraries assigning long codes to symbols having a low occurrence rate to thereby reduce the amount of information.

When image data coded according to the above described procedure is decoded, processing in the reverse order is performed. That is, entropy decoding which is a first decoding procedure is performed first, then inverse quantization and inverse discrete cosine transform which is a second decoding procedure is performed and a decoded image can thereby be obtained.

For decoding, a dedicated integrated circuit can be used which is designed for specialized use of the procedure. This integrated circuit is equipped with a storage area to store input data, input data is temporarily copied to this storage area when entering each decoding procedure, and output after being subjected to processing by each decoding procedure. Especially, in the second decoding procedure, it is possible to apply processing in parallel to each block of the input data, and thereby drastically improve the processing speed compared to a case where no dedicated integrated circuit is used.

However, on the other hand, the storage area for the second decoding procedure of the above described integrated circuit may have an upper limit to the size of data that can be stored at a time. Therefore, in this case, when image data which exceeds this upper limit in size is inputted, the subsequent decoding processing can no longer be continued.

To solve this problem, for example, according to JP-A 6-303594 (Kokai), when a still image which exceeds processable resolution is inputted to a coder capable of coding both video data and still image data, the still image data is divided according to a scheme arranged with a decoder beforehand, and then each piece of the divided still image data is subjected to coding. The decoder applies decoding to each of the plurality of inputted divided coded pieces of data and reconstructs original still image data according to an existing scheme. Using such a method allows a still image which exceeds a processable size to be coded or decoded.

However, the above described method whereby the coder divides and codes image data according to a division scheme arranged between the coder and decoder beforehand and the decoder performs decoding and combining has a problem that the coder is required to perform coding processing conscious of resolution which can be processed by the decoder. Therefore, even when the method described in JP-A 6-303594 (Kokai) is used for still image data sent out from the coder which has no means for data division, this still image data cannot be decoded. In such a circumstance, when communication equipment or a communication system equipped with a coder and decoder is constructed, there is not only a problem that the degree of freedom of design is degraded but also a problem that it is difficult to maintain compatibility with an existing system.

### SUMMARY OF THE INVENTION

According to an aspect of the present invention, there is provided with a decoder which decodes coded image data obtained by applying entropy coding to first data obtained by applying a discrete cosine transform and quantization processing to image data, comprising:

a first decoding unit configured to apply entropy-decoding to the coded image data to obtain the first data;

a dividing unit configured to divide the first data into a plurality of second data each of which has a size equal to or smaller than a first threshold; and

a second decoding unit configured to apply inverse quantization processing and inverse discrete cosine transform to each second data sequentially to obtain a plurality of third data, and

a generating unit configured to generate the image data by synthesizing the plurality of third data.

According to an aspect of the present invention, there is provided with a decoding method which decodes coded image data obtained by applying entropy coding to first data obtained by applying a discrete cosine transform and quantization processing to image data, comprising:

applying entropy-decoding to the coded image data to obtain the first data;

dividing the first data into a plurality of second data each of which has a size equal to or smaller than a first threshold; and

applying inverse quantization processing and inverse discrete cosine transform to each second data sequentially to obtain a plurality of third data, and

generating the image data by synthesizing the plurality of third data.

According to an aspect of the present invention, there is provided with a computer readable medium storing a computer program for causing a computer which decodes coded image data obtained by applying entropy coding to first data obtained by applying a discrete cosine transform and quantization processing to image data, to execute instructions to perform the steps of:

applying entropy-decoding to the coded image data to obtain the first data;

dividing the first data into a plurality of second data each of which has a size equal to or smaller than a first threshold; and

applying inverse quantization processing and inverse discrete cosine transform to each second data sequentially to obtain a plurality of third data, and

generating the image data by synthesizing the plurality of third data.

### BRIEF DESCRIPTION OF THE DRAWINGS

FIG. 1 shows the configuration of a decoder as an embodiment of the present invention;

FIG. 2 is a flow chart illustrating the operation of the decoder;

FIG. 3 shows an example of input information;

FIG. 4 shows a first division;

FIG. 5 shows a second division;

FIG. 6 shows a third division;

FIG. 7 shows output for the first division;

FIG. 8 shows output for the second division;

FIG. 9 shows output for the third division;

FIG. 10 shows another example 1 of division;

FIG. 11 shows another example 2 of division; and

FIG. 12 illustrates a state immediately after writing to the first division is completed in the example of FIG. 11.

### DETAILED DESCRIPTION OF THE INVENTION

Hereafter, an embodiment of the present invention will be explained with reference to the attached drawings.

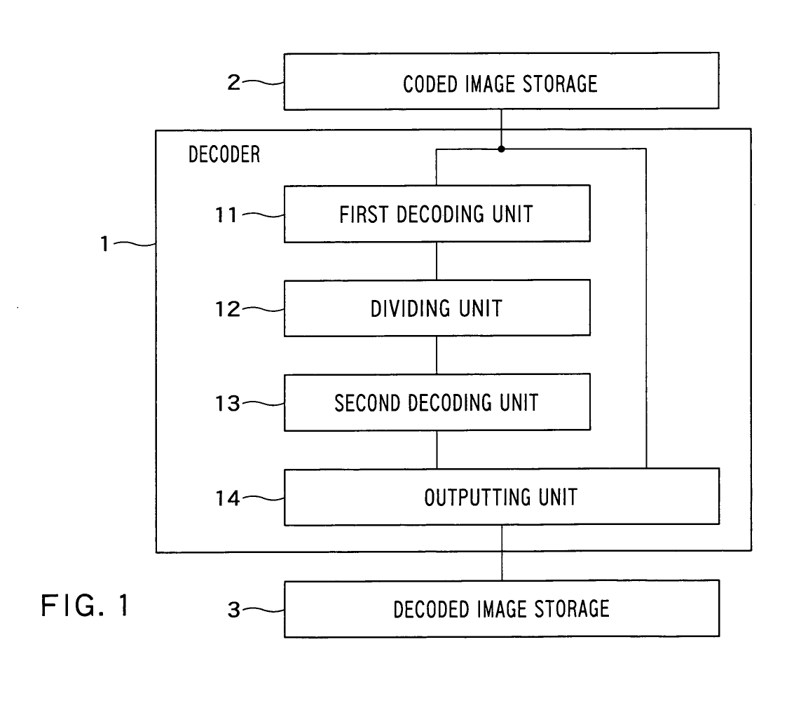

FIG. 1 shows the configuration of a decoder 1 as the embodiment of the present invention. The input side of the decoder 1 is connected to a coded image storage 2 and the output side is connected to a decoded image storage 3.

The coded image storage 2 has a storage area from which data can be read. This storage area stores image data before being decoded by the decoder 1, that is, coded image data. This coded image data is given resolution information indicating resolution (size) of an image before coding by the coder and output position information indicating a desired output position in the storage area of the decoded image storage 3. The set of the coded image data, resolution information and output position information is called “input information.” The input information is transmitted from the coder side and is received through an arbitrary network.

Here, the coded image data is generated on the coder side by being subjected to original image data to discrete cosine transform (DCT) processing and quantization processing as first coding processing and further run-length coding processing and entropy coding processing as second coding processing. The run-length coding processing reduces the amount of data by expressing a portion of the data where zeros appear consecutively using the number of consecutive zeros. The entropy coding processing codes data using codewords having different lengths based on the probability of appearance of each symbol. This embodiment uses both run-length coding processing and entropy coding processing as the second coding processing but the embodiment can also be adapted so as to carry out only entropy coding processing.

The coded image storage 2 inputs input information (coded image data, resolution information, output position information) in the storage area to the decoder 1 according to the user's instructions or the like.

The decoded image storage 3 has a storage area which corresponds to a two-dimensional plane which allows data to be written to an arbitrary position and stores image data (decoded image data) after being decoded by the decoder 1.

The decoder 1 has a first decoding unit 11, a dividing unit 12, a second decoding unit 13 and an outputting unit 14. The second decoding unit 13 has restrictions on the resolution (size) of data that can be processed at a time.

The first decoding unit 11 performs decoding processing (entropy decoding processing and run-length decoding processing) which corresponds to the second coding processing (run-length coding processing and entropy coding processing) carried out on the coder side (not shown). When coded image data is input, the first decoding unit 11 applies first decoding processing (entropy decoding processing and run-length decoding processing) to this coded image data and thereby obtains image data (quantized image data or first data) which corresponds to the condition after the first coding processing (discrete cosine transform (DCT) processing and quantization processing) by the coder. When the coder does not perform run-length coding processing as the second coding processing, the first decoding unit 11 does not perform run-length coding processing on the coded image data.

The dividing unit 12 receives the data (quantized image data) obtained by the first decoding unit 11 as input. The quantized image data inputted to the dividing unit 12 consists of a plurality of blocks whose processing unit is, for example, 8×8=64 pixels. The dividing unit 12 compares the size of the quantized image data inputted with the size processable by the second decoding unit 13 (processable resolution) and divides the quantized image data when the size of the quantized image data inputted is larger than the processable resolution. This division is performed in such a way that the size of each divided piece of quantized image data falls to or below the processable resolution. The divided pieces of quantized image data are outputted one by one. The divided pieces of quantized image data correspond to a plurality of second data.

The second decoding unit 13 has a storage buffer having predetermined resolution (predetermined size) for storing the quantized image data. Upon receiving the quantized image data from the first decoding unit 11, the second decoding unit 13 stores this in the storage buffer and then performs inverse quantization processing and inverse DCT processing on the stored quantized image data in this order. In this way, image data which corresponds to the condition prior to the first coding processing (DCT processing and quantization processing) by the coder is obtained. The second decoding unit 13 outputs the image data (decoded image data or third data) obtained through the inverse quantization processing and the inverse DCT processing to the outputting unit 14.

The outputting unit 14 receives the above described resolution information (resolution of the image prior to the coding by the coder) and output position information (desired output position in the storage area of the decoded image storage 3) from the coded image storage 2 as input. The outputting unit 14 has a storage area for storing the resolution information and output position information and stores the resolution information and the output position information inputted from the coded image storage 2 in this storage area. Furthermore, when the decoded image data is inputted from the second decoding unit 13, the outputting unit 14 writes the decoded image data at a position indicated by the output position information stored in the storage area. The outputting unit 14 corresponds, for example, to a generating unit.

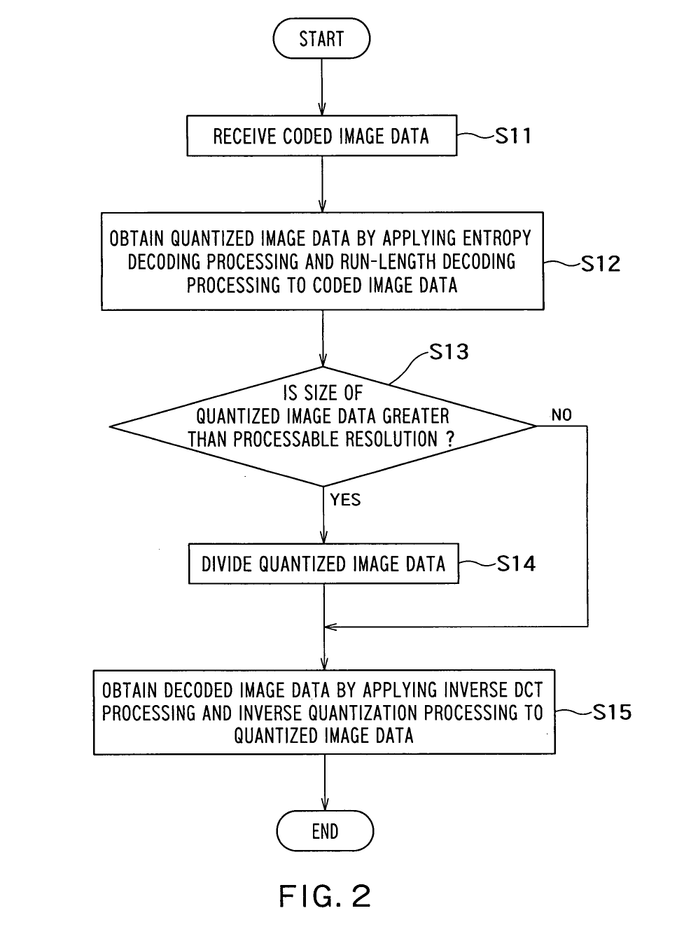

Next, the operation of the decoder 1 according to this embodiment will be explained in detail with reference to the drawings as appropriate. FIG. 2 shows a flow chart to explain the operation of the decoder 1.

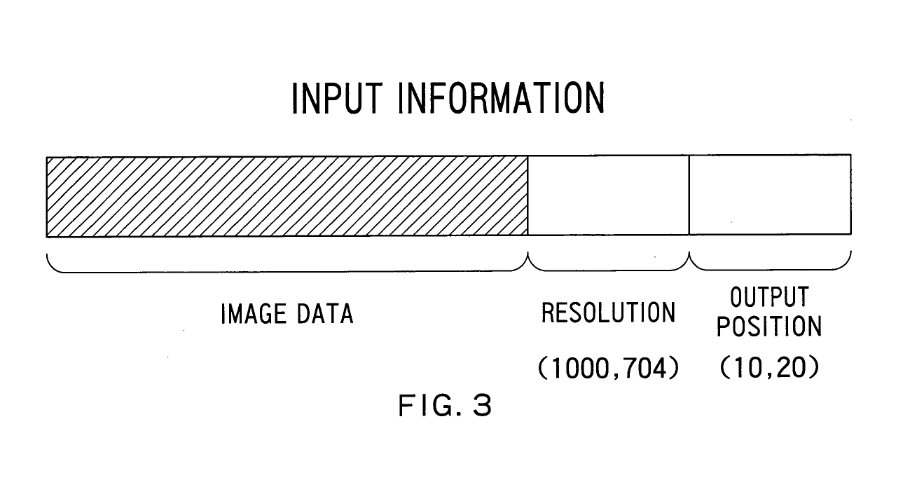

First, the coded image storage 2 inputs the coded image data (image data subjected to DCT processing, quantization processing, run-length coding processing, entropy coding processing on the coder side) stored in the own storage area to the decoder 1 (S11). In this case, the coded image storage 2 also inputs the above described resolution information (resolution of the image prior to coding by the coder) and the above described output position information (desired output position in the storage area of the decoded image storage 3) together. FIG. 3 shows an example of the input information (coded image data, resolution information, and output position information).

In FIG. 3, the resolution of an image prior to coding is expressed by the number of pixels in the horizontal direction and the vertical direction of the image and it is assumed here that the image having resolution of 1000 pixels in the horizontal direction and 704 pixels in the vertical direction (denoted as (1000, 704)) has been inputted. The output position is a numerical value indicating the relative position in the horizontal direction and the vertical direction from the upper left corner of the two-dimensional plane at the decoded image storage 3 which is the output destination after decoding. Here, suppose the storage area of the decoded image storage 3 is a storage area on the two-dimensional plane of 1024 pixels in the horizontal direction and 768 pixels in the vertical direction and suppose image data after decoding is outputted to a position whose position relative to this storage area is 10 pixels in the horizontal direction and 20 pixels in the vertical direction (denoted as (10, 20)).

Out of the above described input information, the coded image data is inputted to the first decoding unit 11, and the resolution information (1000, 704) and output position information (10, 20) of the image are inputted to the outputting unit 14.

Upon receiving the coded image data as input, the first decoding unit 11 analyzes a header part (e.g., JPEG header) of the coded image data and obtains a code table (e.g., Huffman table (DHT)) necessary for entropy coding which is the first decoding. In addition to this, the header part also includes a quantization table (DQT) which becomes necessary for inverse quantization. The first decoding unit 11 performs conversion (rearrangement of a bit sequence) of codes in the coded image data based on the acquired code table. That is, the coded image data is entropy-decoded (S12). Moreover, the first decoding unit 11 applies run-length decoding processing or the like to the converted data and thereby obtains quantized data (quantized image data). Here, the quantized image data consists of a plurality of blocks whose basic unit for processing is, for example, 8×8=64 pixels and the subsequent processing is performed in block units. The quantized image data and the above described header part obtained are outputted to the dividing unit 12.

The dividing unit 12 inquires processable resolution at the second decoding unit 13 from the second decoding unit 13 beforehand and stores this. As described above, the “processable resolution” refers to a maximum data size (resolution) on which the second decoding unit 13 can perform processing (inverse quantization processing and inverse DCT processing) at once. In this example, suppose the processable resolution at the second decoding unit 13 is expressed as a set of numerical values (640, 480) consisting of 640 pixels in the horizontal direction and 480 pixels in the vertical direction.

When the quantized image data is inputted, the dividing unit 12 compares the size of the quantized image data and the above described processable resolution (S13). Here, such a comparison is made by calculating the number of the above described blocks (8×8=64 pixels) for each of the quantized image data and the processable resolution and determining which is greater or smaller. In the case of this embodiment, since the quantized image data inputted from the first decoding unit 11 is 1000 pixels in the horizontal direction and 704 pixels in the vertical direction, this is equivalent to 11000 blocks of 8×8. On the other hand, since the processable resolution is 640 pixels in the horizontal direction and 480 pixels in the vertical direction, this is equivalent to 4800 blocks of 8×8. Therefore, since it is evident from the comparison result that the inputted quantized image data is greater than the processable resolution (YES in S13), the dividing unit 12 starts to divide the inputted quantized image data (S14). When the size of the inputted quantized image data is equal to or smaller than the processable resolution (NO in S13), the process moves to step S15.

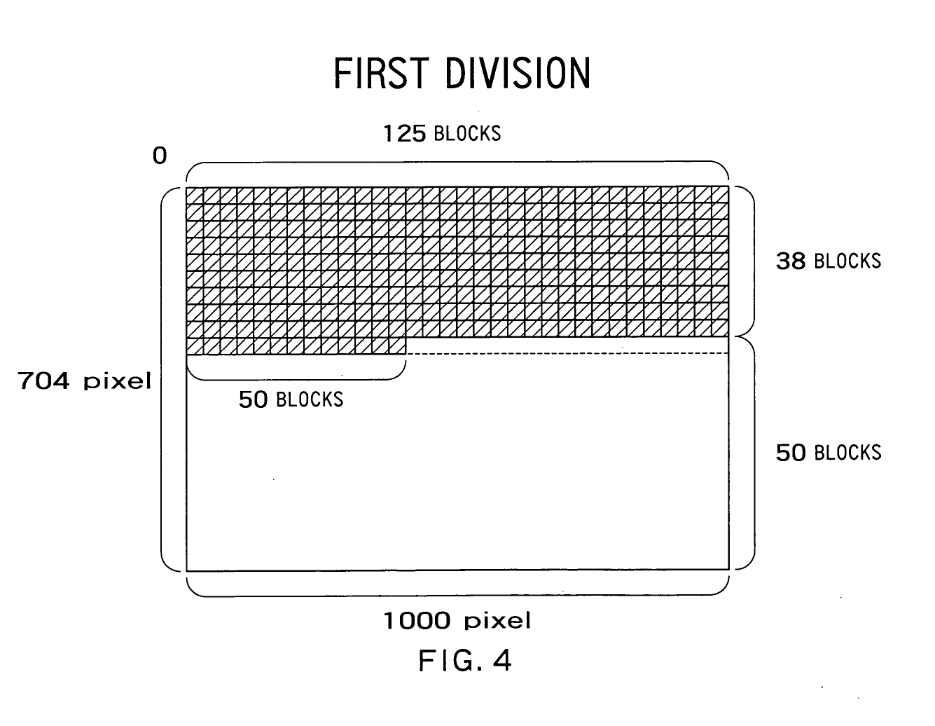

Here, the method of division carried out by the dividing unit 12 will be explained. The dividing unit 12 sequentially scans blocks in the right direction from the block located in the upper left corner of the inputted quantized image data as the starting point. When the scanning reaches the block at the right end (i.e., the upper right corner) of the inputted quantized image data, the scanning position is moved to a block one row below the upper left corner and the scanning continues from there in the right direction again. Scanning is repeated in this way and when the scanning corresponding in number to blocks of processable resolution is completed, the dividing unit 12 outputs the scanned blocks to the second decoding unit 13 as the first divided quantized image data (first division). This situation is shown in FIG. 4. The figure shows the scanned blocks with diagonally shaded areas (125×38+50=4800 blocks). When the scanned blocks are outputted to the second decoding unit 13, the header part received from the first decoding unit 11 is also outputted to the second decoding unit 13.

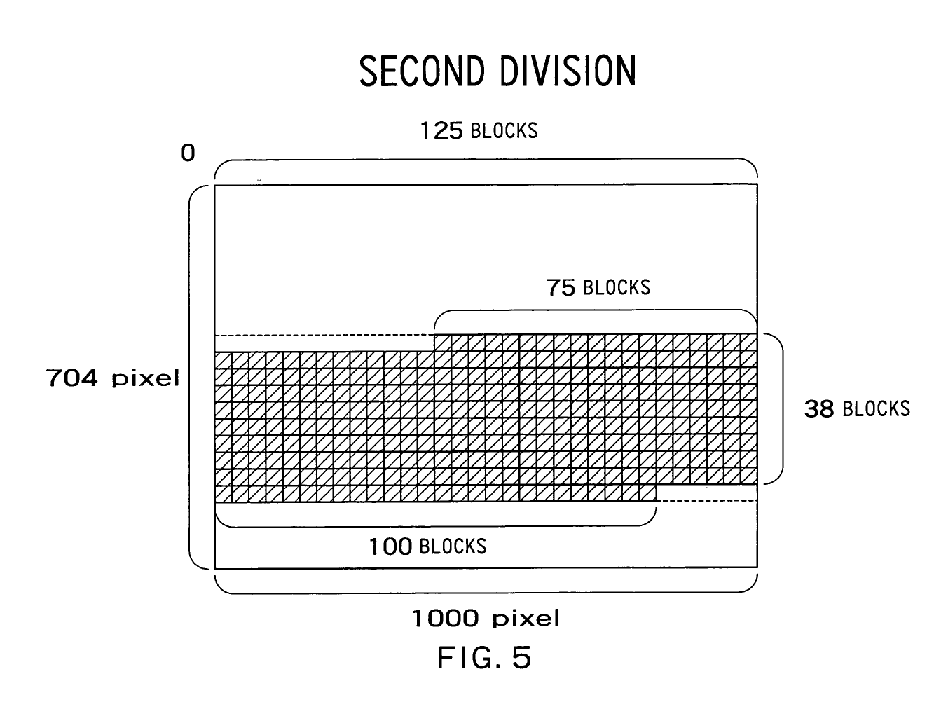

Next, the dividing unit 12 resumes scanning from the part that follows the first division. The method of scanning is the same as that described above. When the scanning corresponding in number to blocks of processable resolution is completed, the dividing unit 12 outputs the scanned blocks to the second decoding unit 13 as the second divided quantized image data (second division). This situation is shown in FIG. 5 (75+125×37+100=4800 blocks).

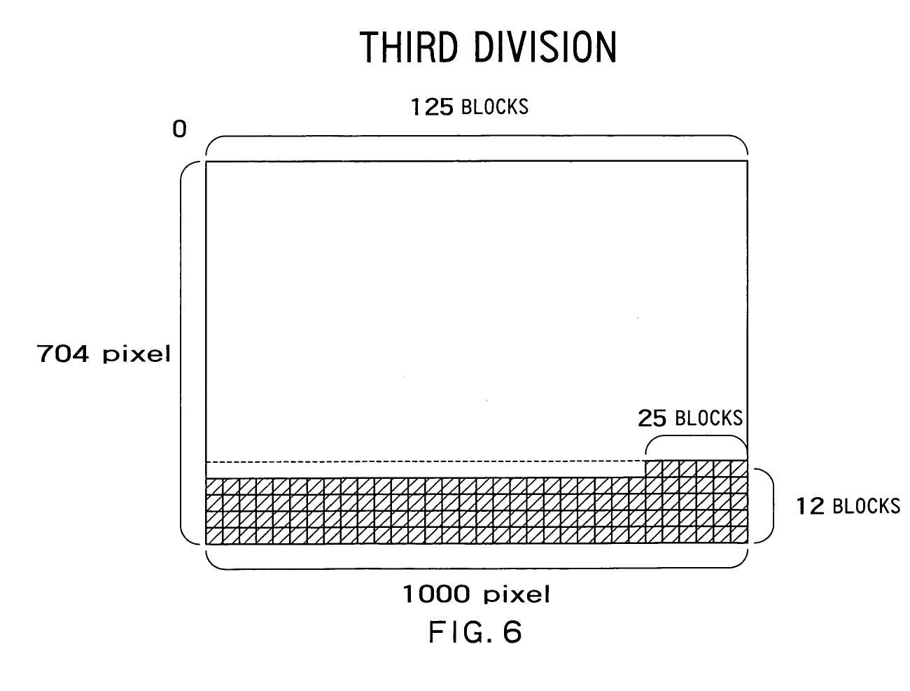

Next, the dividing unit 12 performs scanning from the part that follows the second division. This scanning is performed up to the block at the end point (lower right corner) of the inputted quantized image data and the dividing unit 12 outputs this result to the second decoding unit 13 as the third divided quantized image data (third division). This situation is shown in FIG. 6 (25+125×11=1400).

When quantized image data is inputted from the dividing unit 12, the second decoding unit 13 stores this in the own storage buffer. The second decoding unit 13 then applies inverse DCT processing and inverse quantization processing to the stored quantized image data and obtains the decoded image data in this way (S15).

The quantization table used in the inverse quantization processing is included in the header part of the image data and this table will be used. Alternatively, a quantization table arranged with the coder beforehand may also be used fixedly.

The second decoding unit 13 hands over the image data (decoded image data) obtained through the inverse DCT processing and the inverse quantization processing to the outputting unit 14. When the division shown in FIG. 4 to FIG. 6 is carried out, the second decoding unit 13 sequentially outputs decoded image data (first divided decoded image data) obtained by applying inverse DCT and inverse quantization to the first divided quantized image data, decoded image data (second divided decoded image data) obtained by applying inverse DCT and inverse quantization to the second divided quantized image data and decoded image data (third divided decoded image data) obtained by applying inverse DCT and inverse quantization to the third divided quantized image data to the outputting unit 14.

Upon receiving the resolution information (1000, 704) and the output position information (10, 20) at the decoded image storage 3 from the coded image storage 2, the outputting unit 14 stores the information in the own storage area. When the decoded image data is inputted from the second decoding unit 13, the outputting unit 14 refers to the output position information stored in the own storage area and outputs the decoded image data to the position indicated by the output position information at the decoded image storage 3 (S16). Output in this case is performed in block units and performed according to a procedure which is substantially the same as that of scanning at the dividing unit 12. Hereinafter, a case where the division shown in FIG. 4 to FIG. 6 is performed will be explained in detail using an example.

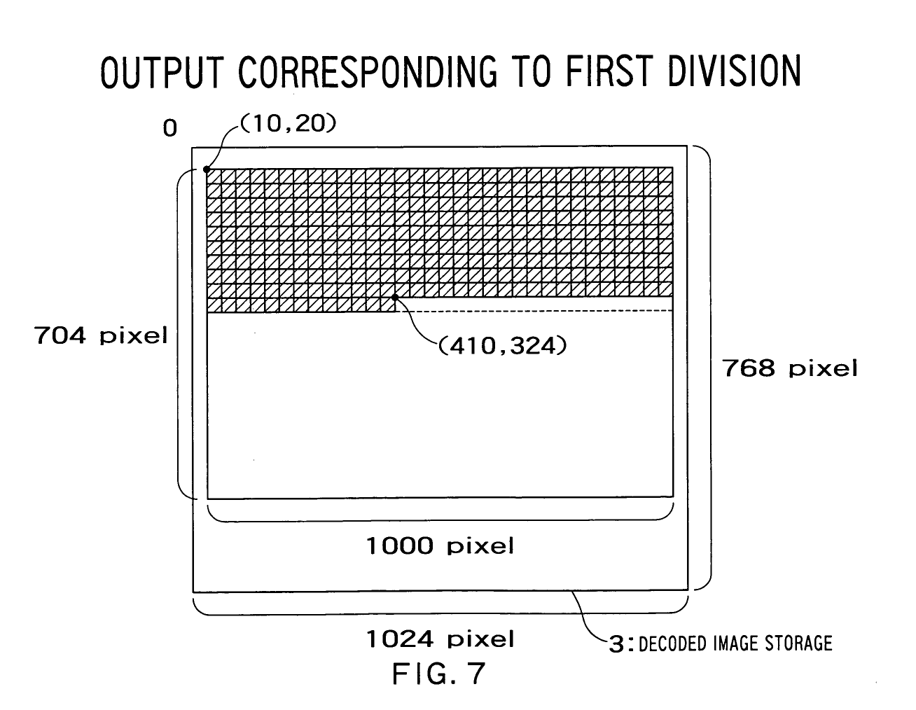

First, from the position (10, 20) indicated by the output position information of the decoded image storage 3 as the starting point, first divided decoded image data (4800 blocks) is sequentially written 1 block at a time in the right direction. When the writing reaches the pixel in the horizontal direction indicated by the resolution information, the writing position is moved to the block one row below the position (10, 20) and the writing continues from there in the right direction again. This situation is shown in FIG. 7. The above described writing is repeated and when the writing of the first divided decoded image data (4800 blocks) is completed, the outputting unit 14 updates the output position information stored in the storage area to the next writing position (here, (410, 324)) and waits for the next second divided decoded image data to be inputted.

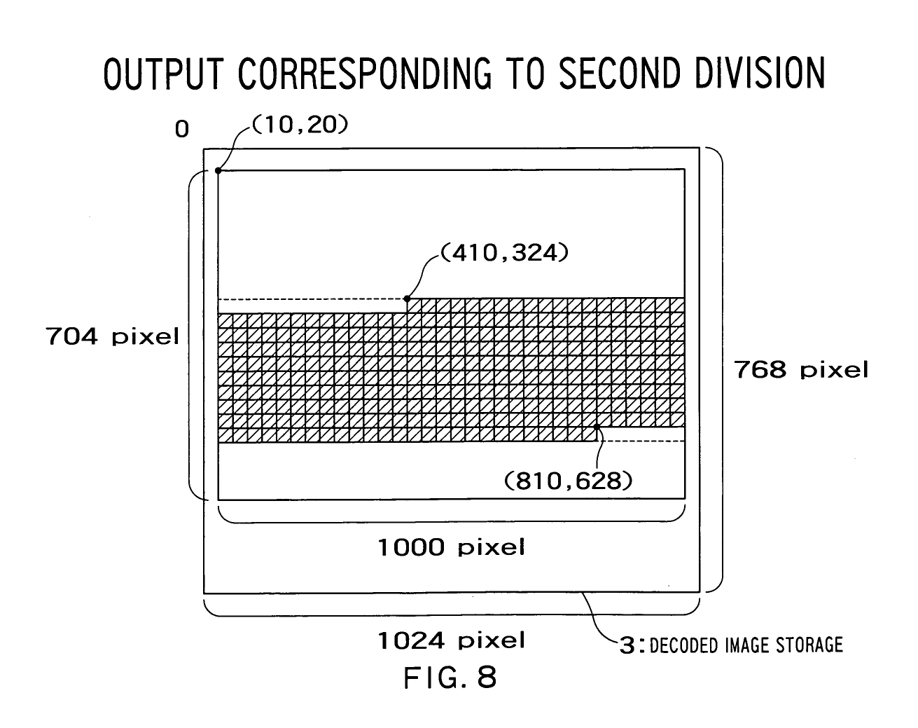

Next, when the second divided decoded image data (4800 blocks) is inputted from the second decoding unit 13, the outputting unit 14 refers to the output position (410, 324) stored in the storage area. The outputting unit 14 starts writing of the received second divided decoded image data from the output position (410, 324) of the decoded image storage 3 as the starting point. This situation is shown in FIG. 8. After completing this writing, the outputting unit 14 updates the output position information stored in the own storage area with (810, 628).

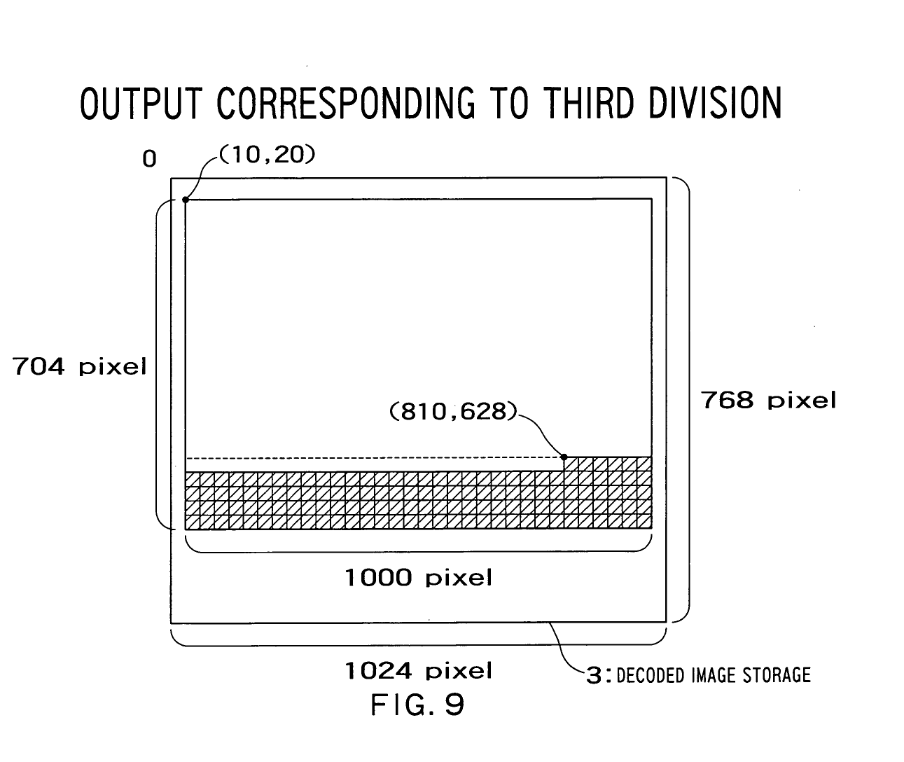

Next, when the third divided decoded image data (1400 blocks) is inputted from the second decoding unit 13, the outputting unit 14 starts writing of the third divided decoded image data from (810, 628) indicated by the output position information. This situation is shown in FIG. 9. As a result, all the divided decoded image data (first to third divided decoded image data) is written into the decoded image storage 3.

In the embodiments explained above, the dividing unit 12 performs division by scanning up to all the (4800) blocks of processable resolution. Various division methods other than the above described one are also available. For example, when there is some restriction on the format of the decoded image data inputted to the decoded image storage 3, it is possible to perform division according to the restriction. An example thereof will be shown below.

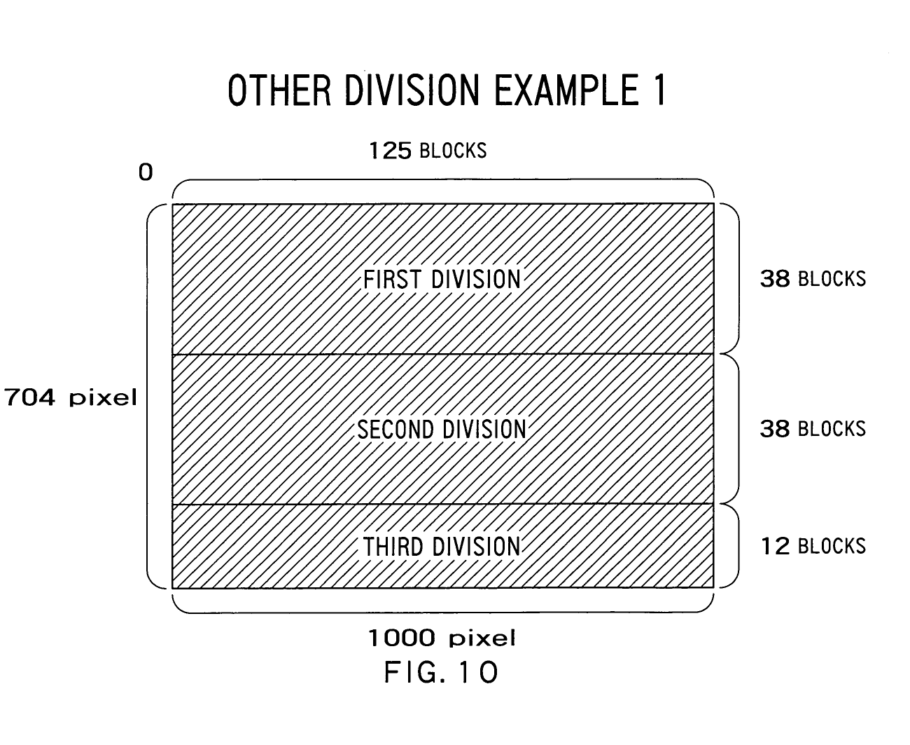

The shape of the decoded image data inputted to the decoded image storage 3 may be limited to rectangle. In order to meet such a limitation of the decoded image storage 3, quantized image data is divided so that the area occupied by the divided decoded image data becomes rectangle. An example of the division in this case is shown in FIG. 10.

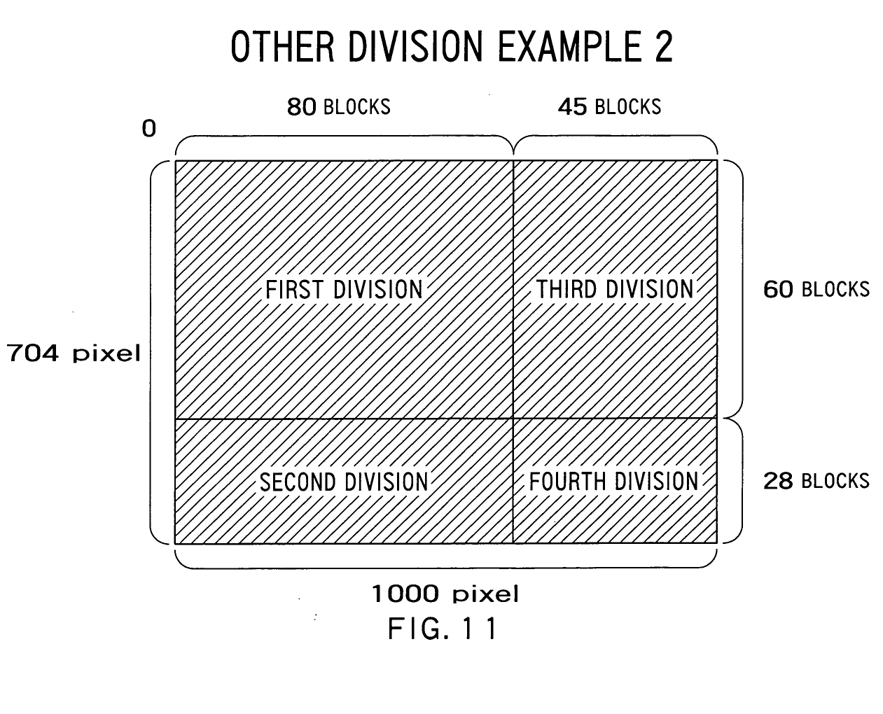

Alternatively, the shape of the decoded image data inputted to the decoded image storage 3 may be limited to rectangle and an upper limit (second threshold and third threshold) may be provided for each of the sizes (resolution) of the decoded image data inputted in the vertical direction and the horizontal direction. In order to meet such limitations of the decoded image storage 3, for example, as shown in FIG. 11, the image data can be divided into four rectangles. The horizontal direction and the vertical direction of each divided decoded image data (first divided decoded image data to the fourth divided decoded image data) are characterized by not exceeding the above described upper limit of the decoded image storage 3. In this case, the dividing unit 12 reports the number of blocks in the horizontal direction and the vertical direction of the first to fourth divided decoded image data to the outputting unit 14 through the second decoding unit 13. The outputting unit 14 refers to this and when writing to the decoded image storage 3, the outputting unit 14 performs output processing while moving the writing position downward by one row every time writing corresponding in number to blocks in the horizontal direction of the first to fourth divided decoded image data is performed.

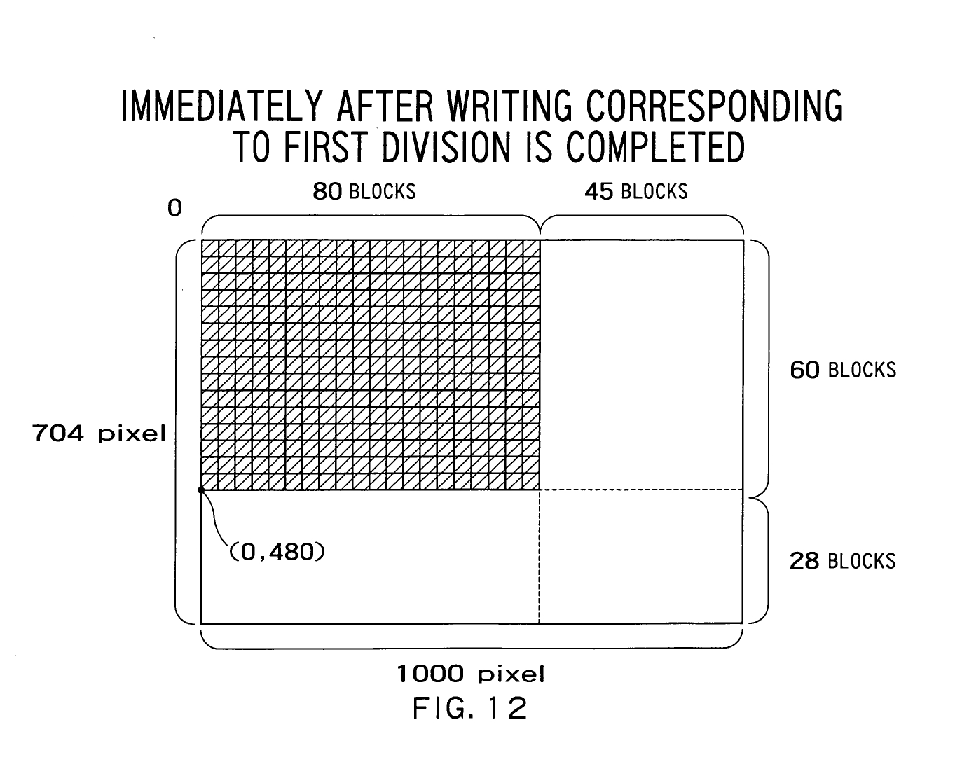

FIG. 12 shows a situation immediately after the writing to the first divided decoded image data is completed. The next writing position is a position (0, 480) moved downward by one row from the position where writing to the first division coded image data is completed. The outputting unit 14 starts writing to the second divided coded image data from here. When recognizing that the writing is completed and the writing position has reached the lowest row of the image, the outputting unit 14 moves the next writing position to (640, 0) and continues writing to the third divided decoded image data and the fourth divided decoded image data.

As described above, according to this embodiment, the first decoding unit performs entropy decoding processing on the coded image data, the second decoding unit then divides the coded image data into processable or lower resolution at once, and therefore the decoder can decode coded image data appropriately (without failure). This eliminates the necessity for the coder side to perform coding conscious of the decoder side, and therefore it is possible to secure the degree of freedom of design and compatibility with the existing system in constructing communication equipment and a communication system equipped with a coder/decoder.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A decoder which decodes coded image data obtained by applying entropy coding to first data obtained by applying a discrete cosine transform and quantization processing to image data, comprising:
a first decoding unit configured to apply entropy-decoding to the coded image data to obtain the first data;
a dividing unit configured to divide the first data into a plurality of second data each of which has a size equal to or smaller than a first threshold; and
a second decoding unit configured to apply inverse quantization processing and inverse discrete cosine transform to each second data sequentially to obtain a plurality of third data, and
a generating unit configured to generate the image data by synthesizing the plurality of third data.

2. The decoder according to claim 1, wherein the dividing unit divides the first image data so that the plurality of third data obtained by converting the plurality of second data become partial images of the image data respectively.

3. The decoder according to claim 2, wherein the dividing unit divides the first data so that a shape of each partial image becomes rectangular.

4. The decoder according to claim 1, wherein the dividing unit divides the first data so that a size in vertical direction and a size in horizontal direction of each second data are equal to or smaller than second and third thresholds respectively.

5. The decoder according to claim 1, wherein the image data is subjected to run-length coding after the quantization processing and before the entropy coding, and
the first decoding unit applies run-length decoding to the coded image data after the entropy decoding.

6. A decoding method which decodes coded image data obtained by applying entropy coding to first data obtained by applying a discrete cosine transform and quantization processing to image data, comprising:
applying entropy-decoding to the coded image data to obtain the first data by;
dividing the first data into a plurality of second data each of which has a size equal to or smaller than a first threshold; and
applying inverse quantization processing and inverse discrete cosine transform to each second data sequentially to obtain a plurality of third data, and
generating the image data by synthesizing the plurality of third data.

7. A computer readable medium storing a computer program for causing a computer which decodes coded image data obtained by applying entropy coding to first data obtained by applying a discrete cosine transform and quantization processing to image data, to execute instructions to perform the steps of:
applying entropy-decoding to the coded image data to obtain the first data by;
dividing the first data into a plurality of second data each of which has a size equal to or smaller than a first threshold; and
applying inverse quantization processing and inverse discrete cosine transform to each second data sequentially to obtain a plurality of third data, and
generating the image data by synthesizing the plurality of third data.
